(19) United States
(12) Patent Application Publication
(10) Pub. No.: US 2014/0310941 A1
(43) Pub. Date: Oct. 23, 2014

(54) Method of Applying Electroluminescent Lighting to Furniture or the Like

(71) Applicants: Kristi Anderson, South Burlington, VT (US); Patricia Anderson, Naperville, IL (US); Kattie Anderson, Enosburg, VT (US)

(72) Inventor: Kristi Anderson, South Burlington, VT (US)

(21) Appl. No.: 14/205,729

(22) Filed: Mar. 12, 2014

Related U.S. Application Data
(60) Provisional application No. 61/788,077, filed on Mar. 15, 2013.

(51) Int. Cl. F21V 33/00; H05B 33/10

(52) U.S. Cl. CPC F21V 33/0012; H05B 33/10
USPC 29/458; 29/428

(57) ABSTRACT

A method of applying electroluminescent material to furniture or the like, the method including the steps of providing a suitable electroluminescent material with attached wiring and also providing a suitable power source, preparing the surface of the furniture or the like for receipt of the electroluminescent material with attached wiring including providing a passageway for the wiring, adhering the suitable electroluminescent material to a surface of the furniture or the like via a double sided adhesive, and passing the wiring through the passageway, placing a clear material above the electroluminescent material, which clear material includes translucent printing, placing an essentially opaque material provided with cut-outs over the clear material so that the printed design may be visible when the electroluminescent material is powered on, sealing the electroluminescent material, the printed clear material, and the essentially opaque material with a clear sealant that is applied over the various components and connecting the attached wiring to the power source.

### TECHNICAL FIELD

The present invention relates to furniture and the like which has been provided with electroluminescent lighting (EL), and more particularly to a method of applying the electroluminescent lighting.

### BACKGROUND OF THE INVENTION

There are many patent which disclose method of assembling electroluminescent lamps, and typical ones are U.S. Pat. Nos. 5,491,377, 5,720,639, 7,582,000 and 2005/0070196. The lamps made by the processes disclosed in these patents are flexible and suitable for use in the present invention. In practice the present invention uses Light Tape® manufactured by the Electro-Luminx Lighting Corporation. The tape is a multi layer electroluminescent material including light emitting phosphors sandwiched between electrodes, one of which is transparent.

Prior patents disclose multiple uses for such electroluminescent lamps. Thus, U.S. Pat. No. 5,444,930 discloses that a thin flexible electroluminescent lamp can be used in a point of purchase display sign. U.S. Pat. No. 5,566,384 discloses a vehicle with an electroluminescent lamp, and more particularly with a silk screen printed lamp attached to a car by adhesive. U.S. Pat. Nos. 6,641,276, 7,316,491, US patent application publication 2011/0198015, and International Publication WO 98/57097 all discloses electroluminescent materials affixed to vehicles. U.S. Pat. No. 6,395,408, US 2008/0044677 and EP1425990 all disclose photoluminesent materials which may be applied to furniture and other structures.

Finally Chinese publications CN28838404 and CN202281122 both disclose electroluminescent material affixed to furniture. However, these patents do not disclose in any detail how the electroluminescent lamps are secured to the furniture, nor do they disclose the manner of powering these lamps.

### OBJECTS AND SUMMARY OF THE INVENTION

It is an object of the present invention to provide a method of applying electroluminescent lamps to the surface of furniture in such a manner that it has the appearance of being an integral part of the furniture, and not something added on as an afterthought. Thus the light emitting material of the present invention is either layered into the surface of the furniture or imbedded into the furniture. Furthermore, it is an object of the present invention to provide designs in the EL surface.

### BRIEF DESCRIPTION OF THE FIGURES

FIG. 1 shows a piece of furniture which has the electroluminescent material layered into the top surface of the furniture or embedded into the top surface of the furniture.

FIG. 2 is a sectional view of the top surface of furniture of the type shown in FIG. 1 showing how the surface of the furniture has been engraved for the receipt of a double sided adhesive, and also showing how a hole has been formed in the surface adjacent the back for the passage of power wires, this view being taken generally along the line A-A in FIG. 1.

FIG. 3 is a view similar to FIG. 2 and shows the addition of the electroluminescent material and a transparent material that printing can be placed on.

FIG. 4 shows additional materials which can be placed on the structure shown in FIG. 3.

FIGS. 5a and 5b shows front and back views of the structure shown in FIG. 4 after various designs have been cut out.

FIG. 6 shows the additional materials of FIG. 4 overlaying a further additional material.

FIG. 7 shows the materials of FIG. 6 placed over the materials shown in FIG. 3, and with the addition of double sided material.

FIG. 8 shows a complete assembly of the electroluminescent material on the engraved furniture with a sealant, and with the power wires having been placed through the passageway.

FIGS. 9 and 10 are wiring diagrams.

### DETAILED DESCRIPTION

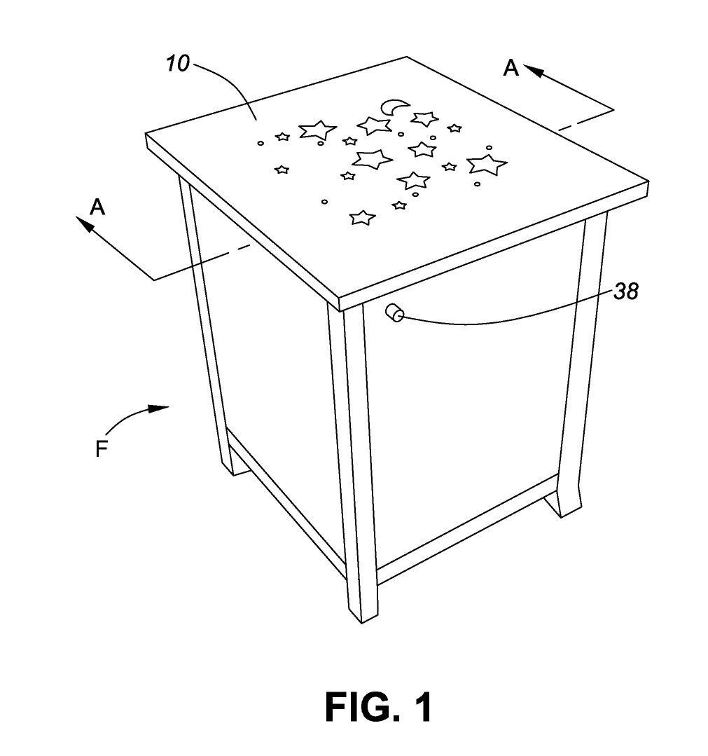

FIG. 1 shows a piece of furniture F in the form of a table which has been modified by the addition of electroluminescent material in accordance with this invention. In the illustrated embodiment the electroluminescent material has been placed on the top surface 10 of the table, the wires (not shown in this view) having been placed through the table top and connected to a switch 38 which controls the current and voltage to the electroluminescent material. The process for assembling the electroluminescent material to the table top is shown in the additional figures. However, it should be noted that while this invention is shown on the top surface 10 of a piece of furniture, it could be applied to other surfaces, such as the sides shown in FIG. 1. Furthermore, in the following description and claims the references to “top”, etc. are merely for convenience and are not intended to be limiting.

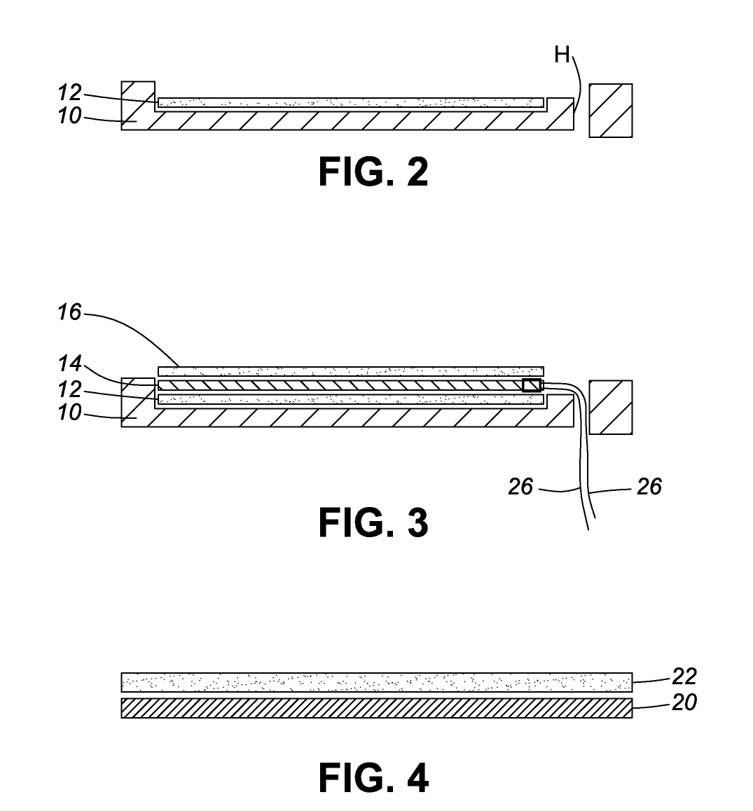

FIG. 2 is a sectional view taken generally along the line A-A in FIG. 1 showing the first steps of applying electroluminescent material to the furniture F. In this FIG, a recess has been formed or engraved in the top surface 10, which recess is of precise dimensions, and it may have been formed by a CNC process. However, it should be noted that CNCing is just option of doing this. In addition, a hole H has been CNCed directly through the surface at the back end for the wiring 26 to be pulled though. In addition, it should be noted that the material of the furniture may be wood or any other material which can be suitably engraved. FIG. 2 also shown a doubled sided adhesive 12 which has been cut to size so that it is essentially of the same dimensions of the engraved recess. The double sided adhesive is preferably a high temperature tolerant adhesive. While a hole H is shown for the wire passageway, a channel could also be formed for the wire passageway.

FIG. 3 shown precisely shaped laminated electroluminescent material 14 with wiring 26 attached. The laminated electroluminescent material is produced by taking electrodes which have a phosphor sandwiched between, applying contacts and wires to the electrodes, and then cold pressing vapor barriers to the structure, at least one of the vapor barriers being transparent. While cold pressing is used, other methods could be employed. FIG. 3 also shows a clear one sided adhesive material 16 that printing can be placed on. The material 16 is placed adjacent the transparent vapor barrier, and it can consist of vinyl, plastic, or any other suitable material that can receive printing. The printing can be via a translucent ink, or a perforated vinyl, or any other type of printing which permits light to pass through. After the surface of the one sided adhesive material receives the printing, it is the pressed onto the laminated electroluminescent material. The double sided adhesive, laminated electroluminescent material with wiring and the clear one sided adhesive material with printing may be built as one piece.

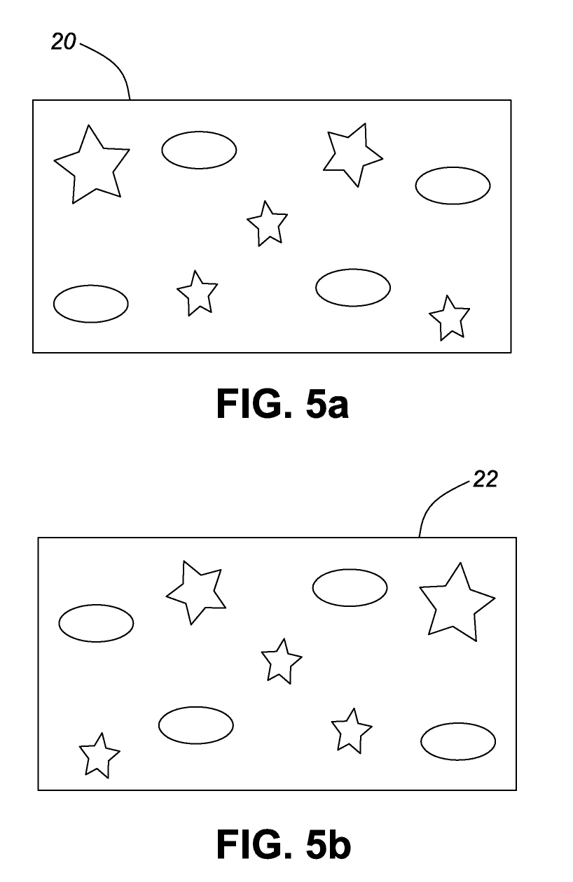

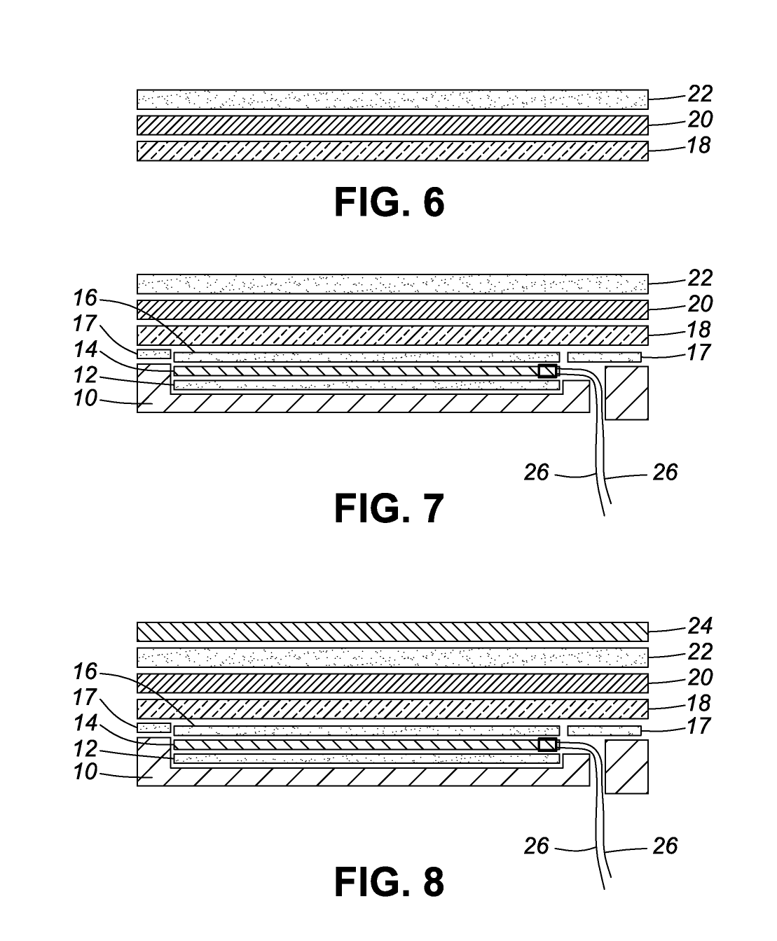

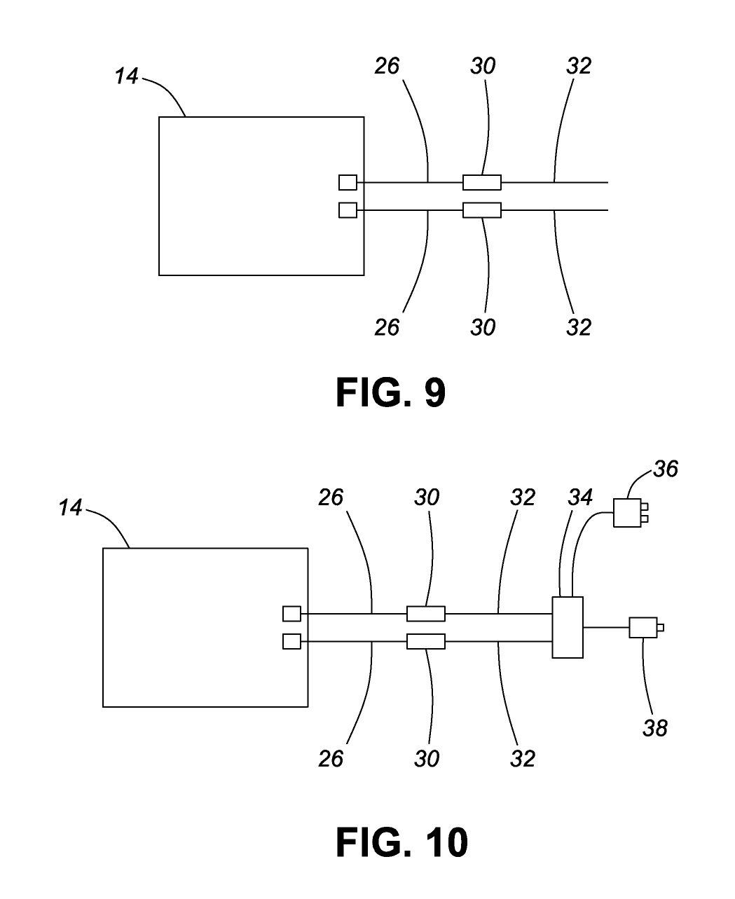

FIG. 4 shows two additional layers of material, one being an essentially opaque one sided adhesive material 20 and the other being a one sided adhesive material 22 that printing can be placed on. A color that can match the color of the furniture may be printed on one side of the material 22, and this is then pressed together with the essentially opaque one sided material. It should be noted that the printing on one side of the material 22 can be any color or design and is not limited to the color that matches the color of the furniture. Once the two pieces 20 and 22 are pressed together, they are placed in a plotter and a set design is cut out completely through the two materials as shown in FIGS. 5a and 5b. The purpose of the cut-outs is so that the light from the electroluminescent light source can pass through the translucent printing on layer 16, while blocking essentially all other light from the electroluminescent material. It is not necessary to use a plotter to cut out the design in the two pieces 20, and 22, and other means may be employed. After the two pieces 20, 22 have the design cut out, a clear material 18 is placed below the two pieces as shown in FIG. 6. The purpose of the clear material is to prevent sealant from pouring through and to cause air bubbles or to make the surface uneven. The clear material 18 may consist of vinyl, plastic, or any other thin material that is clear.

The top layers 18, 20, and 22 are pressed together, and once this is done they can be assembled onto the bottom layers 12, 14, and 16 as shown in FIG. 7. In addition, a high temperature tolerant double sided adhesive 17 is used to bond the surface of the clear material 18 to the top surface 10. The top layers 20, 22 have a design cut out which will match up with the design that was printed on layer 16. Once the two parts have been assembled as shown in FIG. 7, a clear sealant 24 is placed over all to seal the layers down onto the surface. The clear sealant can consist of epoxy, polyester, polyurethane or any chemical that is clear and seals. In a preferred embodiment, once all the layers 12-22 are bonded together and the surface is completely flat with no air bubbles, uneven sections and dust free, all layers can be sealed by using a two component self leveling epoxy resin which is applied over the top, spread out and let dry. The resin may be applied by pouring.

As shown in FIG. 10 a power source 36 is provided which is in turn connected to a DC or AC adapter 34. The wires 26 which have been connected to the electrodes of the laminated electroluminescent material, and which have been pulled thought the passageway H, are connected via connectors 30 to power source wires 32 which extend from the adapter 34. The adapter 34 is provided with a switch 38 which controls the current and voltage flow to the laminated electroluminescent material. The switch 38 may be a dimmer switch so that the output (lumens) of the electroluminescent material can be varied. Alternatively, the switch 38 can be an on/off switch.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. A method of applying electroluminescent lighting to furniture and the like comprising the following steps;
providing a suitable electroluminescent material with attached wiring;
providing a suitable power source;
preparing the surface of furniture or the like for receipt of the electroluminescent material with attached wiring including providing a passageway for the wiring;
adhering the suitable electroluminescent material to a surface of the furniture or the like and passing the wiring through the passageway;
placing a clear material above the electroluminescent material, which clear material may include translucent printing; and
connecting the attached wiring to the power source.

2. The method as set forth in claim 1 wherein the surface of the furniture or the like is prepared by engraving a recess for the receipt of the electroluminescent material which is to be adhered to the surface.

3. The method as set forth in claim 2 wherein the passageway is a hole adjacent the engraved surface, the wiring being passed through the hole.

4. The method as claimed in claim 1 wherein the electroluminescent material is bonded to the surface of the furniture by applying a double sided adhesive to the prepared surface, which double sided adhesive is high temperature tolerant.

5. The method as claimed in claim 4 wherein a clear material printable on one side is placed on the electroluminescent material, and where a design is printed on the clear material.

6. The method as set forth in claim 5 wherein an opaque one sided adhesive material is provided, and wherein portions of the opaque material are cut-out, the cut-out opaque material being adhered to the clear material so the printing is visible.

7. The method as claimed in claim 6 wherein a clear sealant is applied to underlying materials to seal the layers down onto the surface.

8. The method as claimed in claim 1 wherein the attached wiring is connected to either an AC or DC adapter which is in turn connected to the power source.

9. The method set forth in claim 8 wherein a dimmer switch is associated with the adapter.

10. A method of applying electroluminescent lighting to furniture and the like, the electroluminescent lighting having a design, comprising the following steps;
providing a suitable laminated electroluminescent material with attached wiring;
providing a suitable power source;
preparing the surface of furniture or the like for receipt of the laminated electroluminescent material with attached wiring including providing a passageway for the wiring;
adhering the suitable laminated electroluminescent material to a surface of the furniture or the like via a double sided adhesive, and passing the wiring through the passageway;
placing a clear material above the electroluminescent material, which clear material includes translucent printing;
placing an essentially opaque material over the clear material so that the printed design, the opaque material being provided with cut-outs, the electroluminescent material being visible through the cut-outs when powered on;
sealing the laminated electroluminescent material, the printed clear material, and the essentially opaque material with a clear sealant that is applied over the various components; and
connecting the attached wiring to the power source.
